(19) United States
(12) Patent Application Publication
(10) Pub. No.: US 2026/0187602 A1
(43) Pub. Date: Jul. 2, 2026

(54) Outdoor Communication Apparatus and Maintenance Operation Method thereof

(71) Applicant: Nanning FuLian FuGui Precision Industrial Co., Ltd., Nanning (CN)

(72) Inventors: FENG-CHING SU, New Taipei (TW); Yu-Xuan Lin, New Taipei (TW)

(21) Appl. No.: 19/004,701

(22) Filed: Dec. 30, 2024

(51) Int. Cl. G06Q 10/20; G08B 5/36

(52) U.S. Cl. CPC G06Q 10/20; G08B 5/36

(57) ABSTRACT

An outdoor communication apparatus and a maintenance operation method thereof is provided. The outdoor communication apparatus includes a communication device, a flipping mechanism, a rotation mechanism, a base, and a control module. The flipping mechanism is disposed on the communication device, used to rotate the communication device. The rotation mechanism is disposed on the flipping mechanism, and used to rotate the flipping mechanism. The base is disposed on the rotation mechanism. The control module is electrically connected to the flipping mechanism and the rotation mechanism. The control module drives the flipping mechanism and the rotation mechanism to rotate the communication device to a maintenance position according to a maintenance signal.

### FIELD

The subject matter herein generally relates to outdoor communication apparatus.

### BACKGROUND

Mobile communication technology can provide electronic devices, such as mobile phones, for wireless calls and data transmission, and forms a cellular network through mobile base stations. Electronic devices within the coverage of the cellular network can communicate wirelessly through nearby mobile base stations.

For a wider covering range, the mobile base station is generally set up at a high place to reduce the communication signals from being blocked by obstacles between the mobile base station and the electronic device.

In the fifth generation of the mobile communication technology, it has many advantages such as high data transmission rate and reduced delay. However, the covering range of communication signals is small, so mobile base stations need to be installed more densely. One of the current solutions is to install mobile base stations on telegraph poles along the road to increase the distribution density of mobile base stations.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a perspective view of an outdoor communication apparatus in accordance with an embodiment of the present disclosure.

FIG. 2 is a perspective view of a rack device of the outdoor communication apparatus shown in FIG. 1.

FIG. 3 is an exploded view of the rack device shown in FIG. 2.

FIG. 4 is a system diagram of the outdoor communication apparatus shown in FIG. 1.

FIG. 5 to FIG. 8 are perspective views of the outdoor communication apparatus shown in FIG. 1, in different stages of an embodiment of a maintenance operation method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

The term “connect” is defined as directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

In the present disclosure, a rack device or an outdoor communication apparatus can be used to place a communication device on a telegraph pole or wall. The rack device can be used to move and/or rotate the communication device to a position convenient for maintenance, thereby improving the maintenance convenience of the maintenance engineer.

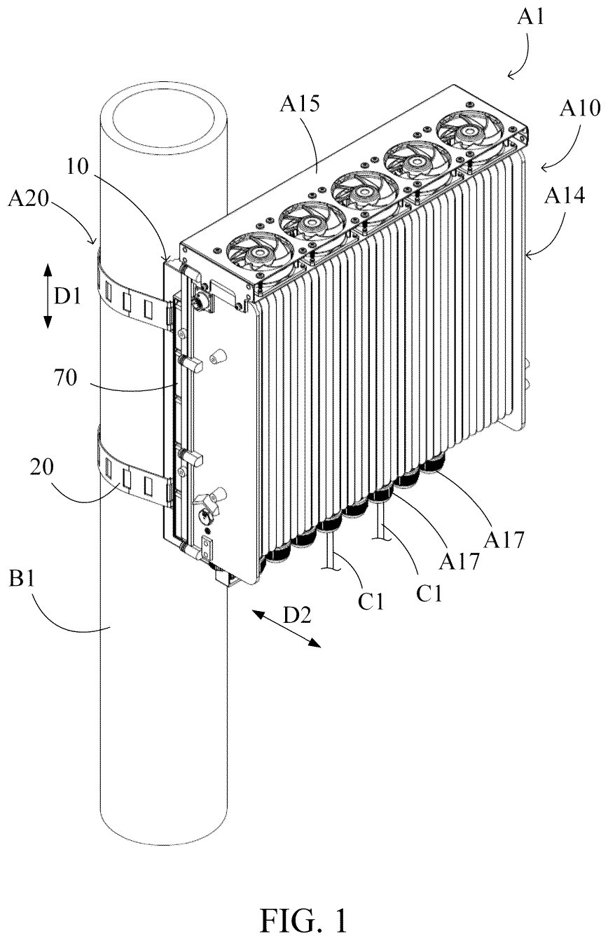

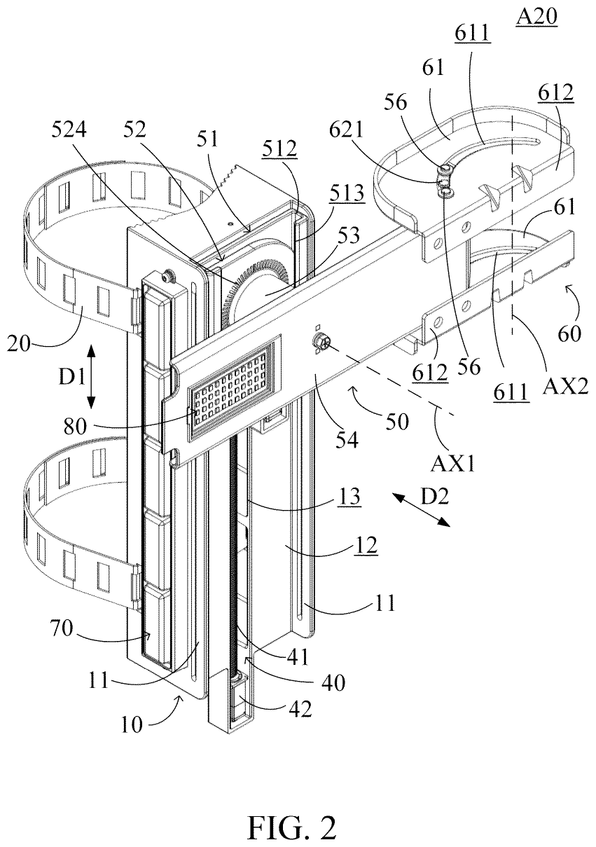

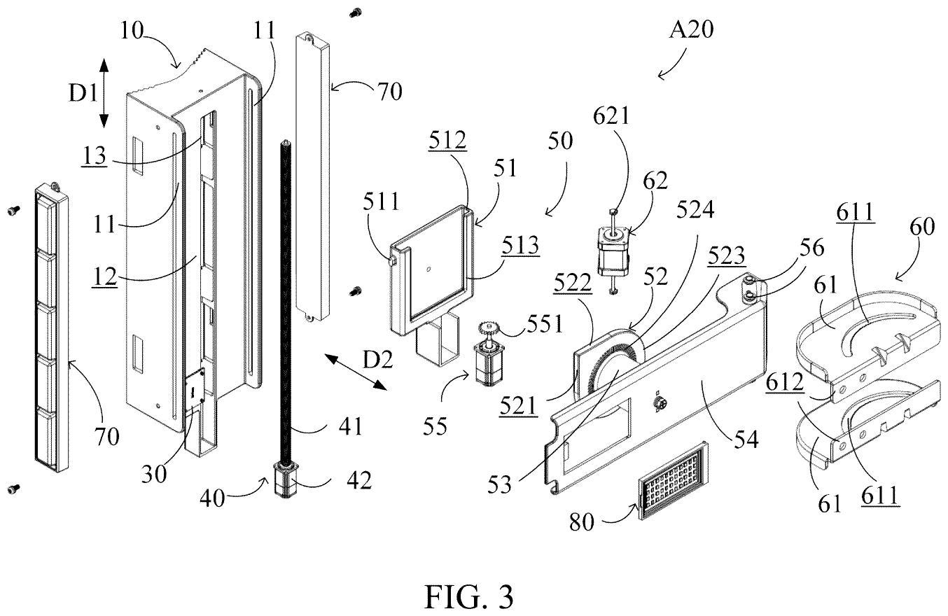

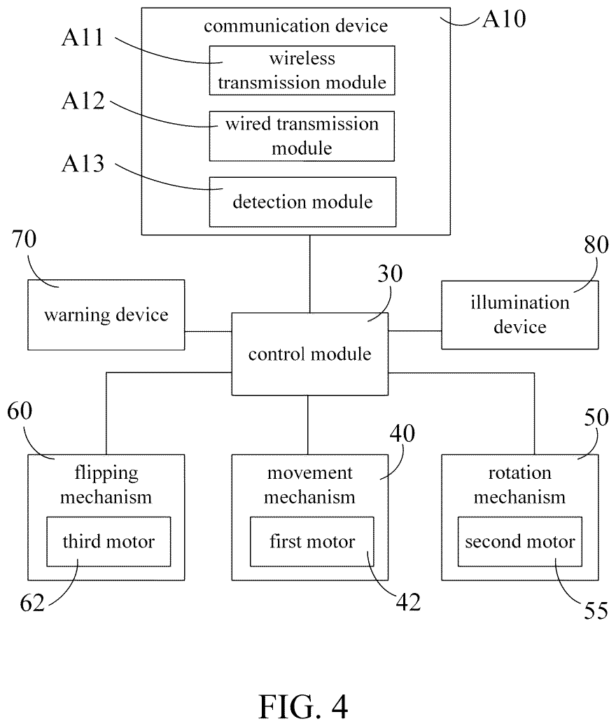

FIG. 1 is a perspective view of an outdoor communication apparatus A1 in accordance with an embodiment of the present disclosure. FIG. 2 is a perspective view of the rack device A20 shown in FIG. 1. FIG. 3 is an exploded view of the rack device A20 shown in FIG. 2. FIG. 4 is a system diagram of the outdoor communication apparatus A1. The outdoor communication apparatus A1 includes a communication device A10 and a rack device A20. For example, the communication device A10 may be a wireless router for transmitting wireless local area network (WLAN) signals or Wi-Fi signals, or the communication device A10 may be a mobile base station (cell site) for transmitting mobile network signals or GSM signals.

The communication device A10 includes a wireless transmission module A11, a wired transmission module A12, and a detection module A13. The wireless transmission module A11 is used to transmit and receive wireless network signals. Moreover, the communication device A10 is connected to cables C1. The wired transmission module A12 can transmit wired network signals via cables C1. The detection module A13 is used to detect internal parameters, such as the temperature, of the communication device A10. The rack device A20 is used to mount the communication device A10 on an object B1. For example, the object B1 can be a telegraph pole or a wall. In this embodiment, the object B1 is a telegraph pole. The telegraph pole can be placed on a ground. The telegraph pole can extend perpendicular to the horizontal ground.

The rack device A20 includes a base 10, a mounting structure 20, a control module 30, a movement mechanism 40, a rotation mechanism 50, a flipping mechanism 60, two warning devices 70, and an illumination device 80. The base 10 includes two tracks 11. The tracks 11 are disposed on the mounting surface 12 of the base 10, and extends a movement direction D1. Moreover, the mounting surface 12 extends perpendicular to an arrangement direction D2. The tracks 11 may be parallel to each other, and separated from each other. In the embodiment, the movement direction D1 may be a vertical direction, and the arrangement direction D2 may be a horizontal direction. The movement direction D1 is perpendicular to the arrangement direction D2. The movement direction D1 is perpendicular to the horizontal ground. The horizontal ground extends the horizontal direction, or extends perpendicular to the vertical direction. Moreover, the base 10 further includes a sliding groove 13, formed on the mounting surface 12. The sliding groove 13 may be an elongated shape. The opening of the sliding groove 13 on the mounting surface 12 may extend in the movement direction D1.

The mounting structure 20 is disposed on the base 10, and is used to mount the base 10 on the object B1. In the embodiment, the mounting structure 20 is a binding strap. The binding strap surrounds the telegraph pole, and is disposed on the base 10.

The control module 30 is disposed in the base 10, and is electrically connected to the movement mechanism 40, the rotation mechanism 50, the flipping mechanism 60, the warning device 70, and/or the illumination device 80. Moreover, the control module 30 is electrically connected to the communication device A10, and/or wirelessly communicates with the communication device A10. The control module 30 may include electronic components such as circuit boards, chips, connectors, and wireless modules, but some of the electronic components are not drawn in the drawings.

The movement mechanism 40 is disposed in the base 10, and is used to move the rotation mechanism 50. The movement mechanism 40 includes a screw rod 41 and a first motor 42. The screw rod 41 is placed in the sliding groove 13 of the base 10, and extends in the movement direction D1. Moreover, the screw rod 41 gears with the rotation mechanism 50. The first motor 42 is placed in the base 10, connected to the screw rod 41, and electrically connected to the control module 30. The control module 30 drives the first motor 42 to rotate the screw rod 41, thereby moving the rotation mechanism 50 upward or downward in the movement direction D1.

The rotation mechanism 50 is movably disposed on the base 10, and connected to the movement mechanism 40. The rotation mechanism 50 is used to rotate the flipping mechanism 60. In the embodiment, the rotation mechanism 50 rotates the flipping mechanism 60 about a first imaginary axis AX1. The first imaginary axis AX1 extends parallel to the arrangement direction D2. The rotation mechanism 50 includes a sliding element 51, a rotation element 52, a connection element 53, a rotation arm 54, and a second motor 55.

The sliding element 51 is movably disposed on the mounting surface 12 of the base 10. In the embodiment, the sliding element 51 includes two sliders 511, a restriction slot 512, and an opening groove 513. Two sliders 511 are disposed on two opposite sides of the sliding element 51, and respectively disposed on two tracks 11. The sliding element 51 extends into the sliding groove 13, and gears with the screw rod 41. Therefore, the tracks 11 and/or the sliding groove 13 can restrict the movement of the sliding element 51 relative to the base 10 in the movement direction D1. The restriction slot 512 is between the sliders 511, and the opening groove 513 is connected to the restriction slot 512. Moreover, the restriction slot 512 and the opening groove 513 are connected to the top surface of the sliding element 51. The top surface of the sliding element 51 is closer to the ground than the bottom surface of the sliding element 51.

The rotation element 52 is rotatably disposed on the sliding element 51. The rotation element 52 is downwardly inserted into the restriction slot 512 via the top surface of the sliding element 51 in the movement direction D1, and is rotatably placed in the restriction slot 512. Since the maximum width of the opening groove 513 is less than the minimum width of the rotation element 52, the sliding element 51 prohibits the rotation element 52 from escaping from the restriction slot 512 via the opening groove 513. The maximum width of the opening groove 513 and the minimum width of the rotation element 52 are measured in the same direction, which is perpendicular to the arrangement direction D2.

The rotation element 52 may be a plate structure, extending perpendicular to the arrangement direction D2. The rotation element 52 includes a first blocking wall 521, a second blocking wall 522, a curved wall 523, and an annular teeth portion 524. The first blocking wall 521 and the second blocking wall 522 may linearly extend, and the first blocking wall 521 is perpendicular to the second blocking wall 522. The curved wall 523 is connected to the first blocking wall 521 and the second blocking wall 522. In the embodiment, the rotation element 52 extends in an imaginary plane. The imaginary plane extends through the first blocking wall 521, the second blocking wall 522, and the curved wall 523. The first blocking wall 521, the second blocking wall 522, and the curved wall 523 extend perpendicular to imaginary plane. The first blocking wall 521 and the second blocking wall 522 are used to limit the rotation angle of the rotation element 52 relative to the sliding element 51. The annular teeth portion 524 surrounds the connection element 53, and is arranged on the front surface of the rotation element 52. The front surface of the rotation element 52 extends perpendicular to the arrangement direction D2.

The connection element 53 is affixed to the front surface of the rotation element 52, and extends in the arrangement direction D2. The annular teeth portion 524 surrounds the connection element 53. The connection element 53 is downwardly inserted to the opening groove 513 via the top surface of the sliding element 51 in the movement direction D1, and is rotatably disposed in the opening groove 513. In the embodiment, the connection element 53 extends along the first imaginary axis AX1, and the first imaginary axis AX1 may extend through the center of the connection element 53. The rotation arm 54 is affixed to the connection element 53, and extends perpendicular to the connection element 53 or the arrangement direction D2.

The second motor 55 is disposed on the sliding element 51, and connected to the rotation element 52. In the embodiment, the second motor 55 includes a rotation gear 551, which gears with the annular teeth portion 524. The second motor 55 is electrically connected to the control module 30. The control module 30 drives the second motor 55 to rotate the rotation gear 551, thereby rotating the rotation element 52 relative to the sliding element 51 about the connection element 53 (or the first imaginary axis AX1). In other words, the control module 30 drives the rotation element 52 to rotate the rotation arm 54 perpendicular to the arrangement direction D2.

The flipping mechanism 60 is disposed on the rotation mechanism 50, and used to rotate the communication device A10. The flipping mechanism 60 includes two flipping elements 61 and a third motor 62. The flipping element 61 is rotatably disposed on one end of the rotation arm 54, and the mounting edge 612 of the flipping element 61 is affixed to the maintenance side of the communication device A10. In the embodiment, the flipping element 61 includes a curved groove 611. The rotation mechanism 50 further includes a restriction post 56 affixed to the rotation arm 54. The restriction post 56 is movably disposed in the curved groove 611, and the restriction post 56 prevents the flipping element 61 from detaching from the rotation arm 54. In the embodiment, the curved groove 611 extends along a circular path. A second imaginary axis AX2 extends through the center of the circular path. The flipping element 61 is rotated about the second imaginary axis AX2. The angle between the arrangement direction D2 and the second imaginary axis AX2 is in a range from 45 degrees to 90 degrees. In the embodiment, the second imaginary axis AX2 is perpendicular to the arrangement direction D2.

The third motor 62 is disposed on the rotation arm 54, and connected to the flipping element 61. In the embodiment, the third motor 62 includes two flipping gears 621 at two opposite sides of the third motor 62. The flipping gears 621 respective gear with the walls with toothed structure of the curved grooves 611. The third motor 62 is electrically connected to the control module 30. The control module 30 drives the third motor 62 to rotate the flipping gear 621, thereby rotating the flipping element 61 relative to the rotation arm 54 about the second imaginary axis AX2.

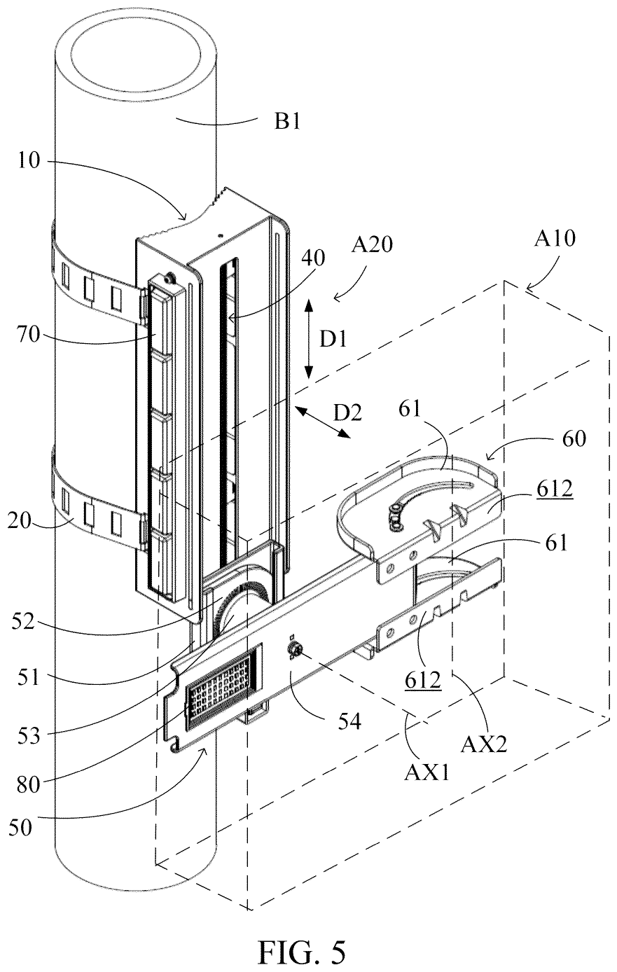

FIG. 5 to FIG. 8 are perspective views of the outdoor communication apparatus A1 in different stages of the maintenance operation method. In the embodiment, the maintenance operation method of the outdoor communication apparatus A1 includes following steps. In the first step, as shown in FIG. 1 and FIG. 2, the mounting structure 20 is used to affix the base 10 to the object B1, and the communication device A10, the rotation mechanism 50, and the flipping mechanism 60 are at an operating position. In the embodiment, the object B1 may be a telegraph pole. In general, in order to enable the outdoor communication apparatus A1 to cover a larger communication range, the communication device A10 should be mounted at least 2.5 meters away from the ground.

At the operating position, the maintenance side of the communication device A10 faces the object B1, the bottom side of the communication device A10 faces away from the object B1. The maintenance side and the bottom side of the communication device A10 are two opposite sides of the communication device A10. In other words, the maintenance side and the bottom side of the communication device A10 extend perpendicular to the arrangement direction D2 (or the horizontal direction). The rear side of the communication device A10 faces the ground, and the front side of the communication device A10 faces away from the ground. The rear side and the front side of the communication device A10 are at two opposite sides of the communication device A10. In other words, the rear side and the front side of the communication device A10 extend perpendicular to the movement direction D1 (or the vertical direction). Moreover, at the operating position, the rotation arm 54 of the rotation element 52 extends perpendicular to the movement direction D1. The mounting edge 612 of the flipping element 61 extends perpendicular to the movement direction D1, and parallel to the rotation arm 54.

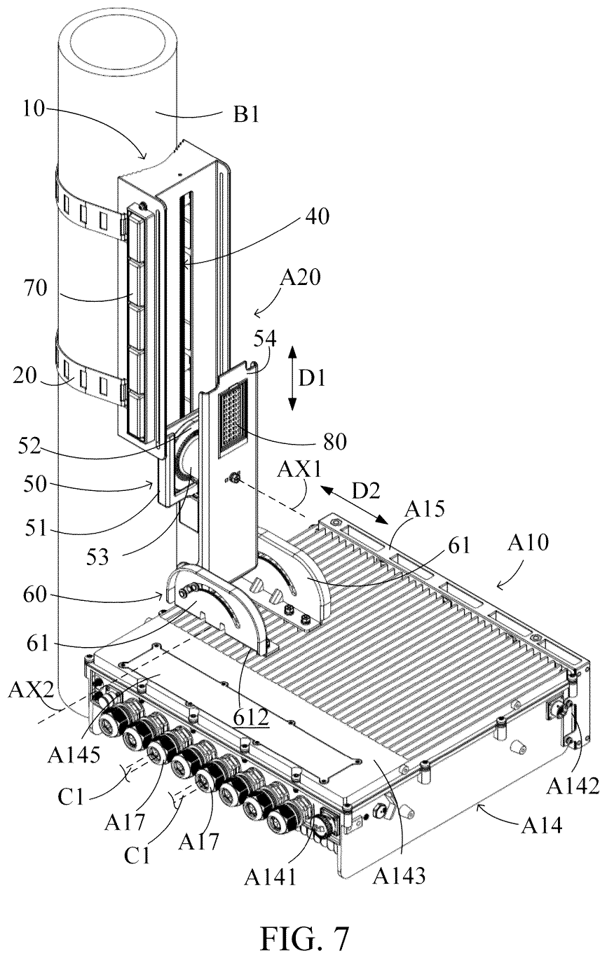

In the embodiment, the mounting edge 612 of the flipping element 61 is affixed to the maintenance side of the communication device A10. Since the cable C1 is connected to the rear plate A141 at the rear side of the communication device A10 as shown in FIG. 7, the degree of the cables C1 is reduced when cable C1 is at the operating position of the communication device A10.

When an abnormal state is detected by the communication device A10, the communication device A10 generates maintenance signals. In the embodiment, the maintenance signals may be wireless signals. The control module 30 receives the maintenance signals by wireless transmission. In another embodiment, the maintenance signals may be wired signals, the control module 30 is electrically connected to the communication device A10. The control module 30 receives the maintenance signal by wires. For example, the abnormal state may be that the temperature within the communication device A10 exceeds a predetermined value. the In addition, the abnormal state may be one or more wired transmission modules A12 or wireless transmission modules A11 of the communication device A10 are damaged or cannot operate normally.

In the embodiment, the maintenance engineer can also send maintenance signals to the control module 30 by operating the portable electronic device to perform routine maintenance inspections or update the communication device A10.

In the second step, the control module 30 drives the movement mechanism 40 to move the rotation mechanism 50 to the operating position in FIG. 1 to the lower position in FIG. 5. Since the communication device A10 and the flipping mechanism 60 are directly or indirectly connected to the rotation mechanism 50, the communication device A10 and the flipping mechanism 60 are also lowered to the lower position. In the embodiment, the lower position is closer to the ground than the operating position. Therefore, it facilitates maintenance engineers to repair the communication device A10.

At the lower position, the maintenance side of the communication device A10 faces the object B1, the bottom side of the communication device A10 faces away from the object B1. The rear side of the communication device A10 faces the ground, and the front side of the communication device A10 faces away from the ground. Moreover, at the lower position, the rotation arm 54 of the rotation element 52 extends perpendicular to the movement direction D1. The mounting edge 612 of the flipping element 61 extends perpendicular to the movement direction D1, and parallel to the rotation arm 54.

In the embodiment, the warning device 70 is disposed on the base 10, and is electrically connected to the control module 30. The control module 30 controls the warning device 70 to generate warning-light signals accord to the maintenance signals. Therefore, the maintenance engineer can determine that the communication device A10 needs maintenance through warning-light signals.

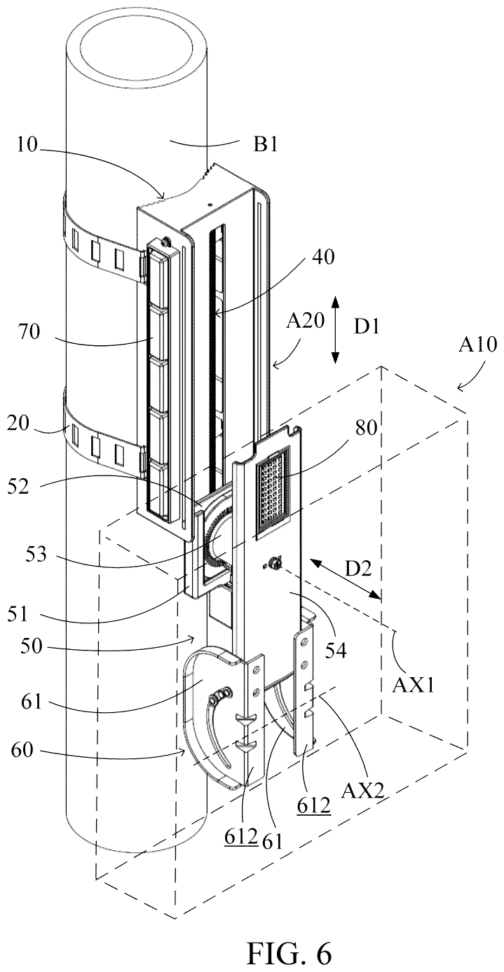

In the third step, the control module 30 drives the rotation mechanism 50 to rotate the flipping mechanism 60 from the lower position in FIG. 5 to the rotation position in FIG. 6 according to the maintenance signals. Since the communication device A10 is directly connected to the flipping mechanism 60, the communication device A10 is also rotated to the rotation position. In the embodiment, the rotation mechanism 50 rotates the flipping mechanism 60 and the communication device A10 90 degrees and perpendicular to the arrangement direction D2. In other words, the flipping mechanism 60 rotates the communication device A10 90 degrees about the first imaginary axis AX1.

In the rotation position, the maintenance side of the communication device A10 faces the object B1, and the bottom side of the communication device A10 faces away from the object B1. The rear side and the front side of the communication device A10 extends perpendicular to the horizontal direction (or the arrangement direction D2). Moreover, in the rotation position, the rotation arm 54 of the rotation element 52 extends in the movement direction D1. The mounting edge 612 of the flipping element 61 extends in the movement direction D1, and extends parallel to the rotation arm 54.

In the fourth step, the control module 30 drives the flipping mechanism 60 to rotate the communication device A10 from the rotation position in FIG. 6 to the maintenance position in FIG. 7 according to the maintenance signals. In the embodiment, the flipping mechanism 60 rotates the communication device A10 90 degrees perpendicular to the movement direction D1 and the arrangement direction D2. In other words, the flipping mechanism 60 rotates the communication device A10 90 degrees about the second imaginary axis AX2.

At the maintenance position, the maintenance side of the communication device A10 faces away from the ground, and the bottom side of the communication device A10 faces the ground. In other words, the maintenance side and the bottom side of the communication device A10 extend perpendicular to the movement direction D1. The rear side and the front side of the communication device A10 extend in the arrangement direction D2. Moreover, at the maintenance position, the rotation arm 54 of the rotation element 52 extends in the movement direction D1. The mounting edge 612 of the flipping element 61 extends in the arrangement direction D2, and perpendicular to the rotation arm 54.

In the embodiment, since the maintenance side of the communication device A10 faces the sky (or away from the ground), it is convenient for maintenance engineers to perform maintenance. By firstly rotating the communication device A10 to the rotation position, and then rotating the communication device A10 to the maintenance position, the cables C1 connected to the communication device A10 can be prevented from colliding with the object B1.

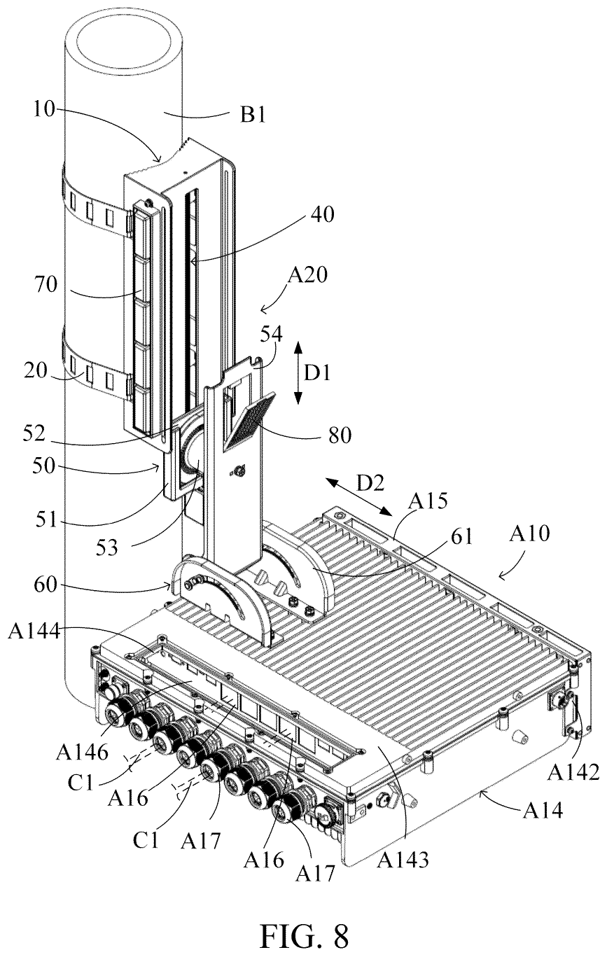

As shown in FIG. 7 and FIG. 8, the communication device A10 further includes a chassis A14, a fan module A15, electrical connectors A16, and waterproof structures A17. The chassis A14 includes a rear plate A141, a front plate A142, a top plate A143, a maintenance cover A145, and an inner partition A146. The rear plate A141 is at the rear side of the communication device A10. The front plate A142 is at the front side of the communication device A10, and parallel to the rear plate A141. The fan module A15 is dispose on the front plate A142. The top plate A143 is at the maintenance side of the communication device A10. The top plate A143 may be perpendicular to the rear plate A141 and/or the front plate A142. The top plate A143 includes a maintenance opening A144. The maintenance cover A145 is detachably disposed on the top plate A143, and covers the maintenance opening A144.

The inner partition A146 is in the chassis A14, and a maintenance chamber is formed between the inner partition A146 and the rear plate A141. The maintenance chamber is connected to the maintenance opening A144. The wireless transmission module A11, the wired transmission module A12, and the detection module A13 in FIG. 4 are disposed in the chassis A14, and between the inner partition A146 and the front plate A142. The electrical connectors A16 are disposed on the inner partition A146. The waterproof structures A17 are disposed on the rear plate A141. The cables C1 extend into the maintenance chamber through the waterproof structures A17 and the rear plate A141. The cables C1 are respectively connected to the electrical connectors A16 in the maintenance chamber.

When the communication device A10 is being repaired, the maintenance cover A145 can be opened relative to the chassis A14 or removed from the chassis A14 to expose the electrical connectors A16 and the cables C1 in the maintenance chamber, thereby making it easier for the maintenance engineer to repair the communication device A10. Moreover, the rack device A20 further includes an illumination device 80. The illumination device 80 is disposed on the rotation arm 54. In the embodiment, the illumination device 80 is rotatably disposed on the rotation arm 54. The illumination device 80 is electrically connected to the control module 30 in FIG. 4. The maintenance engineer can turn on the illumination device 80 to illuminate the communication device A10 during maintenance. Moreover, the maintenance engineer can rotate the illumination device 80 to adjust the illumination angle of the illumination device 80.

In the fifth step, after the communication device A10 is repaired, the maintenance engineer can send out installation signals by operating the portable electronic device. The control module 30 drives the flipping mechanism 60 to rotate the communication device A10 from the maintenance position in FIG. 7 to the rotation position in FIG. 6 according to the installation signals. The control module 30 drives the rotation mechanism 50 to rotate the communication device A10 from the rotation position in FIG. 6 to the lower position in FIG. 5 according to the installation signals. The control module 30 drives the movement mechanism 40 to move the communication device A10 from the lower position in FIG. 5 to the operating position in FIG. 1 according to the installation signals.

In the present disclosure, the outdoor communication apparatus A1 can automatically move the communication device A10 to the maintenance position through the rack device A20 to facilitate maintenance by the maintenance engineer. In addition, the communication device A10 can be automatically restored to the operating position through the rack device A20, thus reducing the burden on the maintenance engineer.

Many details are often found in the relevant art, thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. An outdoor communication apparatus, comprising:
a communication device;
a flipping mechanism disposed on the communication device, and configured to rotate the communication device;
a rotation mechanism disposed on the flipping mechanism, and configured to rotate the flipping mechanism;
a base disposed on the rotation mechanism; and
a control module electrically connected to the flipping mechanism and the rotation mechanism,
wherein the control module drives the flipping mechanism and the rotation mechanism to rotate the communication device to a maintenance position according to a maintenance signal.

2. The outdoor communication apparatus as claimed in claim 1, wherein the communication device generates the maintenance signal when an abnormal state is detected by the communication device, and the control module drives the flipping mechanism and the rotation mechanism according to the maintenance signal.

3. The outdoor communication apparatus as claimed in claim 1, further comprising:
a movement mechanism disposed in the base, and configured to move the rotation mechanism,
wherein the control module is configured to the drive the movement mechanism to move the communication device from an operating position to a lower position.

4. The outdoor communication apparatus as claimed in claim 3, wherein the movement mechanism comprises:
a screw rod disposed in the base, and geared with the flipping mechanism; and
a first motor disposed in the base, connected to the screw rod, and electrically connected to the control module.

5. The outdoor communication apparatus as claimed in claim 1, wherein the flipping mechanism comprising:
a flipping element rotatably disposed on the rotation mechanism; and
a third motor disposed on the rotation mechanism configured to rotate the flipping element, and electrically connected to the control module.

6. The outdoor communication apparatus as claimed in claim 1, wherein the rotation mechanism comprises:
a sliding element disposed on the base;
a rotation element rotatably disposed on the sliding element;
a connection element disposed on the rotation element;
a rotation arm disposed on the connection element, and disposed on the flipping mechanism; and
a second motor disposed on the sliding element, electrically connected to the control module, and configured to rotate the rotation element.

7. The outdoor communication apparatus as claimed in claim 1, further comprising:
a warning device disposed on the base, and electrically connected to the control module,
wherein the control module controls the warning device emits a warning-light signal according to the maintenance signal.

8. The outdoor communication apparatus as claimed in claim 1, wherein the flipping mechanism is rotated about a first imaginary axis by the rotation mechanism, the communication device is rotated about a second imaginary axis by the flipping mechanism rotates, the first imaginary axis extends in an arrangement direction, and an angle between the arrangement direction and the second imaginary axis is in a range from 45 degrees to 90 degrees.

9. The outdoor communication apparatus as claimed in claim 1, further comprising a mounting structure disposed on the base, and configured to mount the base to an object.

10. The outdoor communication apparatus as claimed in claim 1, wherein the communication device further comprising:
a chassis comprising a rear plate, a top plate, and a maintenance cover covering an maintenance opening of the top plate;
an inner partition disposed in the chassis, wherein a maintenance chamber is formed between the inner partition and the rear plate, and is connected to the maintenance opening;
an electrical connector disposed on inner partition; and
a waterproof structure disposed on the rear plate,
wherein a cable extends through the waterproof structure and the rear plate, and connected to the electrical connector in the maintenance chamber.

11. An maintenance operation method applied in an outdoor communication apparatus, the maintenance operation method comprising:
block (a) generating a maintenance signal when an outdoor communication device of the outdoor communication apparatus is at an operating position ;
block (b) driving a movement mechanism to move the communication device from the operating position to a lower position by a control module according to the maintenance signal;
block (c) driving a rotation mechanism to rotate the communication device from the lower position to a rotation position by the control module according to the maintenance signal; and
block (d) driving a flipping mechanism to rotate the communication device from the rotation position to a maintenance position by the control module according to the maintenance signal.

12. The maintenance operation method as claimed in claim 11, wherein the block (a) further comprises:
generating the maintenance signal by the communication device.

13. The maintenance operation method as claimed in claim 11, further comprising:
controlling a warning device to generating a warning-light signal by the control module according to the maintenance signal.

14. The maintenance operation method as claimed in claim 11, further comprising:
block (e) driving the flipping mechanism to rotate the communication device, according to an installation signal, from the maintenance position to the rotation position by the control module.

15. The maintenance operation method as claimed in claim 14, further comprising:
block (f) driving the rotation mechanism to rotate the communication device, according to the installation signal, from the rotation position to the lower position by the control module.

16. The maintenance operation method as claimed in claim 15, further comprising:
block (g) driving the movement mechanism to move the communication device, according to the installation signals, from the lower position to the operating position by the control module.
